(19) United States
(12) Patent Application Publication
(10) Pub. No.: US 2024/0168809 A1
(43) Pub. Date: May 23, 2024

(54) EFFICIENT DYNAMIC RESOURCE ALLOCATION METHOD AND SYSTEM FOR MAXIMIZING UTILIZATION IN KUBERNETES ENVIRONMENT

(71) Applicant: DataStreams Corp., Seoul (KR)

(72) Inventors: Dong-Wook LEE, Seoul (KR); Gyu-Hong CHOI, Seoul (KR); Seung-Tae CHUN, Seoul (KR)

(21) Appl. No.: 18/074,963

(22) Filed: Dec. 5, 2022

(30) Foreign Application Priority Data
Nov. 21, 2022 (KR) 10-2022-0156047

(51) Int. Cl. G06F 9/50

(52) U.S. Cl. CPC G06F 9/5033

(57) ABSTRACT

Disclosed is an efficient dynamic resource allocation method and system for maximizing a utilization in Kubernetes environment that may dynamically adjust a resource quota of a pod running in a Kubernetes cluster, and may step-wisely decrease a request and a limit of resources requested for the pod according to an adjustment rate if an actual resource usage of the pod is within a set range for a certain period of time, may increase a request and a limit for resources of the pod by a square of increased usage if the actual resource usage of the pod is out of the set range for the certain period of time, and may keep a portion of resources additionally secured by dynamically adjusting a resource quota of each of pods for resource increase of the existing pods.

### CROSS-REFERENCE TO RELATED APPLICATION

This application claims the priority benefit of Korean Patent Application No. 10-2022-0156047, filed on Nov. 21, 2022, in the Korean Intellectual Property Office, the disclosure of which is incorporated herein by reference.

### BACKGROUND

### Field of the Invention

The following description of example embodiments relates to an efficient dynamic resource allocation method and system for maximizing utilization in Kubernetes environment.

This work was supported by the Technology development Program (RS-2022-00140586) funded by the Ministry of SMEs and Startups (MSS, Korea).

### Description of the Related Art

In Kubernetes environment, a plurality of users or groups may use resources of a computing cluster including tens to tens of thousands, which are dynamically allocated. Here, a resource request and a resource limit may be performed to allocate an appropriate amount of resources to a user/group on the side of a cluster manager and to secure a sufficient amount of resources on the side of the user/group. Fundamentally, if a cluster includes a sufficient number of physical servers, a sufficient amount of resources may be provided to all the users and groups. However, an amount of idle resources increases, which leads to decreasing the overall utilization. In the case of start-ups or small and medium sized enterprises (SMEs) that desire to build and operate their own cluster in an op-prem form, it is necessary to purchase an appropriate number of expensive physical servers by minimizing an amount of idle resources and by maximizing a utilization. Even in the case of medium sized companies or large enterprises that can afford to purchase physical servers, it is necessary to prevent an unnecessary increase in an amount of idle resources. In reality, although global cloud companies have secured spare resources by continuously expanding physical servers to handle requests from customers without causing problems, an amount of idle resources reaches 70 to 80% or more. Accordingly, services, such as EC2 Spot Instance capable of using such idle resources, are launched and provided.

Therefore, users or groups may request and secure as many resources as possible to not interfere with their work and process due to a lack of resources and, as a result, subsequent requesting users/groups may not use a cluster although there are actually spare resources in a system. For example, with the assumption that a total amount of cluster resources is 100, if group A requests 30, group B requests 40, and group C requests 20, 10 cluster resources to be allocated remain. If group D requests 20, a cluster becomes unavailable due to an insufficient amount of allocable resources. An issue lies in that group D requesting 20 resources is not allowed to enter the cluster although group A is using 5 resources, group B is using 10 resources, and group C is using zero resources at a point in time at which group D makes a request and an actual amount of spare, that is, free resources is 85. Also, if group A used up to 20, group B used up to 25, and group C used up to 15 as a result of verification after all the groups completed the cluster use, it can be verified that an unnecessary resource allocation of (30-20)+(40-25)+(20-15)=30 was performed. The most ideal method to outperform the above issue is to accurately predict a resource usage over time and to allocate an amount of resources required at a point in time when it is required. However, it is not easy to predict a task performance pattern, a computational amount of computing workloads, and the like.

### SUMMARY

Example embodiments provide technology that may dynamically control an allocation amount between an actual amount used and an amount requested. Example embodiments provide a transparency as if a user is not restricted by a resource requested by the user and allow as many users/groups as possible to use a cluster by using a difference between an amount used and an amount requested as spare resources.

According to an aspect, there is provided an efficient dynamic resource allocation method and system for maximizing utilization in Kubernetes environment.

The efficient dynamic resource allocation method for maximizing the utilization in Kubernetes environment performed by a cluster management system includes dynamically adjusting a resource quota of a pod running in a Kubernetes cluster, wherein the dynamically adjusting the resource quota includes step-wisely decreasing a request and a limit of resources requested for the pod according to an adjustment rate if an actual resource usage of the pod is within a set range for a certain period of time, as given as follows:

if |ΔRₜ|≥RANGE, for DURATION then REQ_{adjust}=(REQ_{origin}−R_{avg})×{(10−COUNT_{decrease})×RATE_{adjust}}LIMIT_{adjust}=(LIMIT_{origin}−REQ_{origin})×{(10−COUNT_{decrease})×RATE_{adjust}} [Equation i]

where REQ_{origin} and LIMIT_{origin} denote an original request and an original limit, respectively, REQ_{adjust} and LIMIT_{adjust} denote an adjustment request and an adjustment limit, respectively, R_{actual,t} denotes an actual resource usage of t-time, RANGE denotes a range set as an adjustment detection range, DURATION denotes a certain period of time as a change detection time, RATE_{adjust} denotes an adjustment rate, COUNT_{decrease} denotes a decrease count, ΔRₜ=R_{actual,t}−R_{avg,t}, and R_{avg,t} denotes an average resource usage for t-time; and increasing a request and a limit for resources of the pod by a square of increased usage if the actual resource usage of the pod is out of the set range for the certain period of time, as given as follows:

if |ΔRₜ|>RANGE, for DURATION then REQ_{adjust}=REQ_{adjust,previous}+(ΔRₜ−RANGE)² LIMIT_{adjust}=LIMIT_{adjust,previous}+(ΔRₜ−RANGE)² [Equation ii]

where REQ_{adjust,previous} and LIMIT_{adjust,previous} denote a previous adjustment request and a previous adjustment limit, respectively, REQ_{adjust} and LIMIT_{adjust} denote the adjustment request and the adjustment limit, respectively, RANGE denotes the range set as the adjustment detection range, DURATION denotes the certain period of time as the change detection time, ΔRₜ=R_{actual,t}−R_{avg,t}, R_{actual,t} denotes the actual resource usage of t-time, and R_{avg,t} denotes the average resource usage for t-time.

According to various example embodiments, the dynamic resource allocation method may further include keeping a portion of resources additionally secured by dynamically adjusting a resource quota of each of pods for resource increase of the existing pods, wherein an amount of resources to be kept is determined as follows:

$$\begin{matrix}{r}_{keep} = min ( ( \sum {r}_{i} \times \frac{1}{α \times n} ) \times ( β \times \frac{\sum {r}_{i}}{{r}_{remain}} ) , \sum {r}_{i} ) \\ = min ( \frac{β \times {( \sum {r}_{i} )}^{2}}{α \times n \times {r}_{remain}} , \sum {r}_{i} )\end{matrix} \qquad [ Equation iii ]$$

where i denotes 1, 2, . . . , n corresponding to a sequence of pods participating in a resource quota adjustment, rᵢ denotes an amount of resources secured through a resource quota adjustment of an i^{th} pod, Σrᵢ denotes a total amount of secured resources, rᵣₑₘₐᵢₙ denotes an amount of originally remaining resources, rₖₑₑₚ denotes an amount of resources to be kept among an amount of secured resources,

$$\sum {r}_{i} \times \frac{1}{α \times n}$$

denotes an amount of basic resources to be kept as available among the amount of secured resources, a denotes a weight for a number of pods,

$$β \times \frac{\sum {r}_{i}}{{r}_{remain}}$$

denotes a weight rate of the amount of resources to be kept, and 3 denotes a weight for a rate of the amount of resources.

According to various example embodiments, a resource may be allocated to a new pod within rᵣₑₘₐᵢₙ+(Σrᵢ−rₖₑₑₚ).

According to various example embodiments, in the above [Equation i], minimum values of REQ_{adjust} and LIMIT_{adjust} may be R_{avg,t} and REQ_{origin}, respectively.

According to various example embodiments, in the above [Equation ii], minimum values of REQ_{adjust} and LIMIT_{adjust} may be REQ_{origin} and LIMIT_{origin}, respectively.

According to some example embodiments, by dynamically adjusting a resource quota of a pod running in a Kubernetes cluster, it is possible to prevent occurrence of a resource starvation even through there is a sufficient amount of spare, that is, free resources unused due to excessive requests and to maximize a utilization of cluster resources. Also, it is possible to provide a transparency to a user such that the user may perform a desired task without recognizing a situation in which an amount of resources requested by the user is actually dynamically adjusted. Also, a manager or a cluster may use most of resources.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a cluster management system according to an example embodiment; and

FIG. 2 is a flowchart illustrating a dynamic resource allocation method of a cluster management system according to an example embodiment.

### DETAILED DESCRIPTION OF THE DRAWINGS

Hereinafter, example embodiments are described with reference to the accompanying drawings.

Kubernetes, which groups a plurality of physical servers into a single virtualized cluster and enables a container-based operation, is becoming a standard for modern software development and operation. Kubernetes may group more than tens of thousands of physical servers into a single cluster and thereby operate the same, and also provides functions, such as self-healing, auto-scaling, and the like, and provides a stable computing environment. Also, for container scheduling and efficient operation, Kubernetes provides a resource quota (ResourceQuota) function of allocating resources by namespace and a limit range (LimitRange) function capable of limiting resources of a pod. In a situation in which an amount of resources is sufficient, a resource management function provided by Kubernetes may effectively operate. However, in a situation in which competition occurs due to a resource starvation, a preemption occurs and a resource usage of the entire cluster decreases regardless of presence of free resources. Herein, proposed is dynamic resource allocation technology that allows a plurality of users to use a cluster by guaranteeing a maximum amount of resources required for each namespace and pod and by increasing a resource utilization of the entire cluster.

In Kubernetes, when a pod is created, a resource allocation status is determined using a resource request and a resource limit. Initially, a request upper limit and a limit upper limit for pods created in a namespace through a resource quota are designated for the namespace. When creation of a pod is requested with a request and a limit, whether it is within a request upper limit of the namespace in addition to a request sum of existing created pods and whether it is within a limit upper limit of the namespace in addition to a limit sum of the existing created pods may be verified. If a condition is met, the pod may be created.

Stepwise Decreasing of Resource Quota

When a resource usage of a pod does not change for a certain period of time within a set range, a request and a limit may decrease in a stepwise manner.

Hereinafter, REQ_{origin} and LIMIT_{origin} denote an original request and an original limit, respectively, REQ_{adjust} and LIMIT_{adjust} denote an adjustment request and an adjustment limit, respectively, R_{actual,t} denotes an actual resource usage of t-time, RANGE denotes an adjustment detection range, DURATION denotes a change detection time, RATE_{adjust} denotes an adjustment rate, and COUNT_{decrease} denotes a decrease count.

When the user requests creation of a pod with the original request (REQ_{origin}) and the original limit (LIMIT_{origin}), whether to create the pod is determined according to a Kubernetes mechanism.

If the actual resource usage (R_{actual,t}) is within the set range (RANGE) for the certain period of time (DURATION) as given by the following [Equation 1] after creation of the pod, the adjustment request (REQ_{adjust}) and the adjustment limit (LIMIT_{adjust}) are determined according to the adjustment rate (RATE_{adjust}).

For example, in the case of creating a pod, when the pod is created by being requested with request=30 and limit=100, monitoring of the actual resource usage starts. Here, the adjustment detection range is set to 3, the change detection time is set to 30 seconds, and the adjustment rate is set to 10%.

If a usage measured per second for 30 seconds is average of 10, a minimum of 8, and a maximum of 12, an adjustment condition is met and adjustment of the request and the limit starts. The request decreases by 10% of a difference between an existing requested value and an average value. The limit decreases by 10% of a difference between an existing requested value and a request value. The adjustment is performed to the same value in the same adjustment phase.

In the example, the adjustment is performed such that request=28 and limit=93 in decrease count of 1 by adjusting the request by (30-10)*10%=2 and by adjusting the limit by (100-30)*10%=7. A minimum value of the request adjustment is average value+adjustment detection request and a minimum value of the limit is the original request value.

In the example, if the decrease count exceeds 10 due to no continuous change in the actual resource usage, request=13 and limit=30.

if |ΔRᵣ|≥RANGE, for DURATION then REQ_{adjust}=(REQ_{origin}−R_{avg})×{(10−COUNT_{decrease})×RATE_{adjust}}LIMIT_{adjust}=(LIMIT_{origin}−REQ_{origin})×{(10−COUNT_{decrease})×RATE_{adjust}} [Equation 1]

In Equation 1, ΔRₜ=R_{actual,t}−R_{avg,t}, R_{avg,t} denotes an average resource usage for t-time (t-DURATION, t), and minimum values of REQ_{adjust} and LIMIT_{adjust} denote R_{avg,t} and REQ_{origin}, respectively.

### Exponential Increasing of Resource Quota

If a usage increases beyond an adjustment detection range in the progress of an adjustment phase, there is a need to increase a request and a limit.

If the increased usage exceeds a request value, return to a request and a limit requested is performed immediately.

Otherwise, as in the following [Equation 2], the request and the limit increase by a square of an increased value and a reference value is rest to the increased value.

In the aforementioned example, if the decrease count reaches 5, request=20 and limit=65. Here, if the usage reaches 15 and exceeds the detection range, the request and the limit increase by a square ((15-13)²=4) of an exceeding value and become 24 and 69, respectively.

If a reference point changes to 15 and a subsequent usage is measured as 21 and exceeds the detection range again, a quota increases in the same manner. (21-18)²=9, request=33, and limit=78. Here, since the request exceeds the original request value, the request is set to 30 that is the initial value.

If the usage does not exceed 14 for the next 30 seconds, the rouges and the limit decrease by entering a new phase.

if |ΔRₜ>RANGE, for DURATION then REQ_{adjust}=REQ_{adjust,previous}+(ΔRₜ−RANGE)² LIMIT_{adjust}=LIMIT_{adjust,previous}+(ΔRₜ−RANGE)² [Equation 2]

In Equation 2, REQ_{adjust,previous} and LIMIT_{adjust,previous} denote a previous adjustment request and a previous adjustment limit, respectively, REQ_{adjust} and LIMIT_{adjust} denote the adjustment request and the adjustment limit, respectively, RANGE denotes the range set as the adjustment detection range, DURATION denotes the certain period of time as the change detection time, ΔRₜ=R_{actual,t}−R_{avg,t}, R_{avg,t} denotes the average resource usage for t-time (t-DURATION, t), and minimum values of REQ_{adjust} and LIMIT_{adjust} denote REQ_{origin} and LIMIT_{origin}, respectively.

Cluster Level Resource Quota Control

By applying stepwise decreasing and exponential increasing technology to each pod, available resources may be additionally secured and changed at a cluster level.

If all of available resources secured through application of technology are consumed in response to a new pod creation request, fail occurs when resources of existing pods need to be expanded. Transparency representing that a request and a limit requested by users is guaranteed may not be provided to the users.

Therefore, without allocating all of additionally secured resources, a portion of the secured resources needs to correspond to an increase in resources of existing pods. Here, as in the following Equation 3, an amount of resources to be kept is calculated based on a number of pods to which the technology is applied and an actual amount of remaining resources.

Basically, an amount of rescores to be secured is calculated in inverse proportion to a number of pods that participates in resource adjustment and an amount of secured resources is adjusted based on a ratio between originally remaining resources and the secured resources.

$$\begin{matrix}{r}_{keep} = min ( ( \sum {r}_{i} \times \frac{1}{α \times n} ) \times ( β \times \frac{\sum {r}_{i}}{{r}_{remain}} ) , \sum {r}_{i} ) \\ = min ( \frac{β \times {( \sum {r}_{i} )}^{2}}{α \times n \times {r}_{remain}} , \sum {r}_{i} )\end{matrix} \qquad [ Equation 3 ]$$

In Equation 3, i denotes a sequence (1, 2, . . . , n) of pods participating in a resource adjustment, rᵢ denotes an amount of resources secured through a resource adjustment of an i^{th} pod, Σrᵢ denotes a total amount of secured resources, rᵣₑₘₐᵢₙ denotes an amount of originally remaining resources, and rₖₑₑₚ denotes an amount of resources to be kept among an amount of secured resources.

$$\sum {r}_{i} \times \frac{1}{α \times n}$$

X denotes an amount of basic resources to be kept as available among the amount of secured resources. Here, a denotes a weight for a number of pods and has a default value of 2.

$$β \times \frac{\sum {r}_{i}}{{r}_{remain}}$$

denotes a weight rate of the amount of resources to be kept. Here, β denotes a weight for a rate of the amount of resources and has a default value of 1.

Therefore, resources may be allocated to objects that enter a new cluster within rᵣₑₘₐᵢₙ+(Σrᵢ−rₖₑₑₚ).

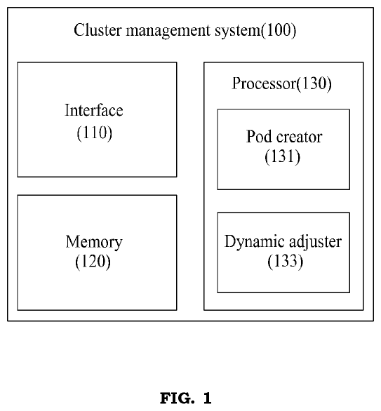

FIG. 1 is a diagram illustrating an example of a cluster management system 100 according to an example embodiment.

Referring to FIG. 1, the cluster management system 100 includes an interface 110, a memory 120, and a processor 130. The interface 110 is provided for interfacing with an external device, that is, a user/group. The memory 120 stores a variety of data used by the cluster management system 100. Data includes at least one program and input data or output data related thereto. The program is stored in the memory 120 as software that includes at least one instruction. The processor 130 operates the cluster management system 100 by executing the program stored in the memory 130. Through this, the processor 130 performs data processing or operation. Here, the processor 130 executes the instruction stored in the memory 120.

According to various example embodiments, the processor 130 may include a pod creator 131 and a dynamic adjuster 133. The pod creator 131 creates a pod in a Kubernetes cluster. The dynamic adjuster 133 dynamically adjusts a resource quota of a pod running in the Kubernetes cluster. In detail, the dynamic adjuster 133 step-wisely decreases a request and a limit of resources requested for a pod according to an adjustment rate, or increases the request and the limit for resources of the pod by a square of an increased usage. In addition, the dynamic adjuster 133 keeps a portion of resources additionally secured by dynamically adjusting a resource quota of each of pods for resource increase of the existing pods.

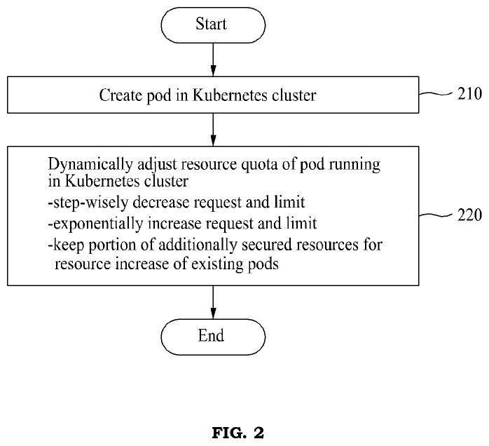

FIG. 2 is a flowchart illustrating a dynamic resource allocation method of the cluster management system 100 according to an example embodiment.

Referring to FIG. 2, in operation 210, the cluster management system 100 creates a pod in a Kubernetes cluster. In detail, when a user/group requests creation of a pod with a request and a limit, the pod creator 131 of the processor 130 verifies whether it is within a request upper limit of a namespace in addition to a request sum of existing created pods and whether it is within a limit upper limit of a namespace in addition to a limit sum of existing created pods. When a condition is met, the pod creator may create the pod.

In operation 220, the cluster management system 100 dynamically adjusts a quota. In detail, if an actual resource usage of a pod is within a set range for a certain period of time as in [Equation 1], the dynamic adjuster 133 of the processor 130 step-wisely decreases a request and a limit of resources requested for the pod according to an adjustment rate. Also, if the actual resource usage of the pod is out of the set range for the certain period of time as in [Equation 2], the dynamic adjuster 133 increases a request and a limit for resources of the pod by a square of increased usage.

Here, the dynamic adjuster 133 of the processor 130 keeps a portion of resources additionally secured by dynamically adjusting a resource quota of each of pods for resource increase of the existing pods. In detail, an amount of resources to be kept is determined according to the above [Equation 3]. Therefore, the pod creator 131 allocates resources to a new pod within an amount of available resources.

According to some example embodiments, by dynamically adjusting a resource quota of a pod running in a Kubernetes cluster, it is possible to prevent occurrence of a resource starvation even through there is a sufficient amount of spare, that is, free resources unused due to excessive requests and to maximize a utilization of cluster resources. Also, it is possible to provide a transparency to a user such that the user may perform a desired task without recognizing a situation in which an amount of resources requested by the user is actually dynamically adjusted. Also, a manager or a cluster may use most of resources.

The apparatuses described herein may be implemented using hardware components, software components, and/or a combination thereof. For example, apparatuses and components described herein may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. A processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied permanently or temporarily in any type of machine, component, physical equipment, virtual equipment, a computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable storage mediums.

The methods according to the example embodiments may be recorded in non-transitory computer-readable media including program instructions to implement various operations embodied by a computer. Also, the media may include, alone or in combination with the program instructions, data files, data structures, and the like. The program instructions recorded in the media may be specially designed for the example embodiments or may be known to those skilled in the computer software art and thereby available. Examples of non-transitory computer-readable media include magnetic media such as hard disks, floppy disks, and magnetic tapes; optical media such as CD ROM and DVD; magneto-optical media such as floptical disks; and hardware devices that are specially configured to store and perform program instructions, such as read-only memory (ROM), random access memory (RAM), flash memory, and the like. Examples of the program instructions include a machine language code such as produced by a compiler and an advanced language code executable by a computer using an interpreter.

While this disclosure includes specific example embodiments, it will be apparent to one of ordinary skill in the art that various alterations and modifications in form and details may be made in these example embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An efficient dynamic resource allocation method for maximizing a utilization in Kubernetes environment performed by a cluster management system, the dynamic resource allocation method comprising:
dynamically adjusting a resource quota of a pod running in a Kubernetes cluster,
wherein the dynamically adjusting the resource quota comprises:
step-wisely decreasing a request and a limit of resources requested for the pod according to an adjustment rate if an actual resource usage of the pod is within a set range for a certain period of time, as given as follows:
if |Δrₜ|≥RANGE, for DURATION then REQ_{adjust}=(REQ_{origin}−R_{avg})×{(10−COUNT_{decrease})×RATE_{adjust}}LIMIT_{adjust}=(LIMIT_{origin}−REQ_{origin})×{(10−COUNT_{decrease})×RATE_{adjust}} [Equation i]
where REQ_{origin} and LIMIT_{origin} denote an original request and an original limit, respectively, REQ_{adjust} and LIMIT_{adjust} denote an adjustment request and an adjustment limit, respectively, R_{actual,t} denotes an actual resource usage of t-time, RANGE denotes a range set as an adjustment detection range, DURATION denotes a certain period of time as a change detection time, RATE_{adjust} denotes an adjustment rate, COUNT_{decrease} denotes a decrease count, ΔRₜ=R_{actual,t}−R_{avg,t}, and R_{avg,t} denotes an average resource usage for t-time; and
increasing a request and a limit for resources of the pod by a square of increased usage if the actual resource usage of the pod is out of the set range for the certain period of time, as given as follows:
if |ΔRₜ|>RANGE, for DURATION then REQ_{adjust}=REQ_{adjust,previous}+(ΔRₜ−RANGE)² LIMIT_{adjust}=LIMIT_{adjust,previous}+(ΔRₜ−RANGE)² [Equation ii]
where REQ_{adjust,previous} and LIMIT_{adjust,previous} denote a previous adjustment request and a previous adjustment limit, respectively, REQ_{adjust} and LIMIT_{adjust} denote the adjustment request and the adjustment limit, respectively, RANGE denotes the range set as the adjustment detection range, DURATION denotes the certain period of time as the change detection time, ΔRₜ=R_{actual,t}−R_{avg,t}, R_{actual,t} denotes the actual resource usage of t-time, and R_{avg,t} denotes the average resource usage for t-time.

2. The dynamic resource allocation method of claim 1, further comprising:
keeping a portion of resources additionally secured by dynamically adjusting a resource quota of each of pods for resource increase of the existing pods,
wherein an amount of resources to be kept is determined as follows:
$$\begin{matrix}{r}_{keep} = min ( ( \sum {r}_{i} \times \frac{1}{α \times n} ) \times ( β \times \frac{\sum {r}_{i}}{{r}_{remain}} ) , \sum {r}_{i} ) \\ = min ( \frac{β \times {( \sum {r}_{i} )}^{2}}{α \times n \times {r}_{remain}} , \sum {r}_{i} )\end{matrix} \qquad [ Equation iii ]$$
where i denotes 1, 2, . . . , n corresponding to a sequence of pods participating in a resource quota adjustment, rᵢ denotes an amount of resources secured through a resource quota adjustment of an i^{th} pod, * denotes a total amount of secured resources, rᵣₑₘₐᵢₙ denotes an amount of originally remaining resources, rₖₑₑₚ denotes an amount of resources to be kept among an amount of secured resources,
$$\sum {r}_{i} \times \frac{1}{α \times n}$$
denotes an amount of basic resources to be kept as available among the amount of secured resources, a denotes a weight for a number of pods,
$$β \times \frac{\sum {r}_{i}}{{r}_{remain}}$$
denotes a weight rate of the amount of resources to be kept, and 3 denotes a weight for a rate of the amount of resources.

3. The dynamic resource allocation method of claim 2, wherein a resource is allocated to a new pod within rᵣₑₘₐᵢₙ+(Σrᵢ−rₖₑₑₚ).

4. The dynamic resource allocation method of claim 2, wherein, in the above [Equation i], minimum values of REQ_{adjust} and LIMIT_{adjust} are R_{avg,t} and REQ_{origin}, respectively.

5. The dynamic resource allocation method of claim 1, wherein, in the above [Equation ii], minimum values of REQ_{adjust} and LIMIT_{adjust} are REQ_{origin} and LIMIT_{origin}, respectively.
